(19) United States
(12) Patent Application Publication
(10) Pub. No.: US 2012/0195703 A1
(43) Pub. Date: Aug. 2, 2012

(54) Skidd Nott - A Means and Method to Prevent Drill Walk

(75) Inventor: Gerald Joseph Le Clair, W. Melbourne, FL (US)

(73) Assignee: Mr. Gerald Joseph Le Clair, W. Melbourne, FL (US)

(21) Appl. No.: 13/019,982

(22) Filed: Feb. 2, 2011

(51) Int. Cl. B23B 47/32

(52) U.S. Cl. 408/110

(57) ABSTRACT

An attachment to a hand-held power drill comprising:
drill mount
wing screw
spring rods
compression springs
pressure pins
pin ring

The attachment is mated with the drill by sliding drill mount 24 to the drill seat and tightening wing screw 40. Drill mount 24 can be made of metal or any standard manufacturing polymer. The inside surface must be suitable for gripping the drill seat under moderate pressure from wing screw 40. Wing screw 40 is an off the shelf item that must sized to hold said attachment to said drill seat. Spring rods 35 are hollow or solid cylinders of metal between drill mount 24 to which they are fixedly attached, and pin ring 28 where they are disposed by a slip fit. Compression springs 20 encircle spring rods 35 and are sized in length to provide pressure between drill mount 24 and pin ring 28. In operation, compression springs 20 transfer pressure from the user to the drill bit and pressure pins 29. Pressure pins 29 are pointed metal pins fixedly attached to pin ring 28 and receive pressure from pin ring 28 which in turn receives pressure from compression springs 20 which are seated in drill mount 24. Pin ring 28 is a disk of solid hard material with threaded blind holes 32 to receive pressure pins 29 and spring rod through holes 39 to receive spring rods 35. Pin ring 28 must be of sufficient thickness and spring rod through holes 39 must be of fine enough tolerance so as to maintain perpendicularity to spring rods 35 during operation.

### CROSS REFERENCE TO RELATED APPLICATIONS

None

### FEDERALLY SPONSORED RESEARCH

Not Applicable

### SEQUENCE LISTING

Not Applicable

### BACKGROUND OF THE INVENTION

1. Field of the Invention

The present invention relates to the general area of construction, using power tools and in particular, the use of a power drill on concrete, concrete block, stone, masonry, brick or aggregate. Such materials are heavy, dense and non-uniform in composition. Certain areas within are often harder and more difficult to drill through than others. When a rotating drill encounters this discontinuity it is often pushed laterally causing the drill to “walk” or skid thereby deforming an otherwise cylindrical hole. The hole becomes unusable and the user must take corrective measures. This may involve using a larger part in the hole, filling and re-drilling the hole or finding a new location. In any event, quality, productivity and timeliness suffer. The present invention attempts to remedy all cases of drill walk by using pressure pins with sharp points, high compression, short stroke springs to grip the textured surface of said materials.

2. Prior Art

TABLE 1
Summary of Prior Art with Essence of the Invention

| Name | U.S. Pat. No. | Date | Essence of Invention |
|---|---|---|---|
| Feinberg | 4,637,087 | Jan. 20, 1987 | |
| Shimma, et al. | 7,383,893 | Jun. 10, 2008 | Technique to alleviate vibration |
| Phillips | 7,367,757 | May 6, 2008 | Selects bit gripping assemblies |
| Mikiya, et al. | 7,121,773 | Oct. 17, 2006 | Low profile drill |
| Fields | 7,052,216 | May 30, 2006 | T-bracket force magnifier |
| Languasco | 6,964,545 | Nov. 15, 2005 | Attachment for bits and flashlight |
| Le Picq | 6,860,682 | Mar. 1, 2005 | Drill guide |
| Ito | 6,844,519 | Jan. 18, 2005 | Electric sparking drill |
| Albrightson | 6,820,339 | Nov. 23, 2004 | Right-angle accessory saw |
| Ishiwata, et al. | 6,806,435 | Oct. 19, 2004 | Electric discharge machine drill |
| Frauhammer, et al. | 6,766,868 | Jul. 27, 2004 | Combination drilling/chiseling |
| | | | hammer |
| Shih | 6,590,178 | Jul. 8, 2003 | Combination drilling/tapping |
| | | | electro-discharge machining |
| | | | (EDM) drill |
| Lin | 6,554,289 | Apr. 29, 2003 | Anti-slip type electric drill chuck |
| Wightman | 6,499,219 | Dec. 31, 2002 | Hand held electric drill |
| Tsai | 6,435,285 | Aug. 20, 2002 | Structure for enhancing torque |
| | | | output |
| Hsueh | 6,409,181 | Jun. 25, 2002 | Combination type electric drill |
| | | | chuck structure |
| Tinken | 6,264,407 | Jul. 24, 2001 | Portable electric railroad rail drill |
| Granado | 6,264,211 | Jul. 24, 2001 | Reciprocating saw attachment |
| Hashimoto | 6,065,658 | May 23, 2000 | Apparatus for holding an electric |
| | | | drill that is worn by a user |
| Setsuko | 5,839,518 | Nov. 24, 1998 | Centrifugal force-controlled |
| | | | coupling switch |
| Khoury | 5,797,302 | Aug. 25, 1998 | Screwdriver adaptation |
| Thurler, et al. | 5,690,451 | Nov. 25, 1997 | Depth stop assembly |
| Enzmann, et al. | 5,551,927 | Sep. 3, 1996 | Torque limiter |
| Chung | 5,533,843 | Jul. 9, 1996 | Case with power supply |
| Earth, et al. | 5,533,581 | Jul. 9, 1996 | Variable angle electric drill |
| Hwong | 5,494,115 | Feb. 27, 1996 | Electric hammer drill |
| Musil | 5,439,236 | Aug. 8, 1995 | Apparatus for supporting a paint |
| | | | stirring stick |
| Chang | 5,327,685 | Jul. 12, 1994 | Built-in grinding equipment |
| Watanabe, et al. | 5,129,467 | Jul. 14, 1992 | Electric hammer drill including a |
| | | | vacuum dust collecting device |
| Sheen | 5,004,054 | Apr. 2, 1991 | Single adjuster ring to control |
| | | | output speed and torque |
| Chen | 4,949,463 | Aug. 21, 1990 | Attachable sawing device |
| Sorensen | 4,912,415 | Mar. 27, 1990 | Sonde for conveying drilled out |
| | | | earth up to a surface of the earth |
| Hayes | 4,801,780 | Jan. 31, 1989 | Dielectric cover that acts as a |
| | | | torque tube |
| Heinsius, et al. | 4,785,544 | Nov. 22, 1988 | Spirit level accessory |
| Fallen | 4,768,652 | Sep. 6, 1988 | Case for displaying and storing |
| | | | electric tools |

Shimma et al., discloses an invention to provide an effective technique to alleviate vibration in the electric hammer drill. According to the invention, a representative electric hammer drill is provided with a body, a motor, a striker, a cylinder, a first and second power transmitting mechanisms, a power switching mechanism, a mode changing mechanism and a coupling mechanism. The mode changing mechanism is disposed on the upper surface of the body and can change between hammer-drill mode and hammer mode. The coupling mechanism is disposed between the mode changing mechanism and the power switching mechanism. The coupling mechanism extends along the peripheral surface of the cylinder and transmits the mode changing movement of the mode changing mechanism to the power switching mechanism by moving in the longitudinal direction of the cylinder. Because the mode changing mechanism is disposed on the upper surface of the body and the coupling mechanism extends along the peripheral surface of the cylinder to move in the longitudinal direction of the cylinder, the center of gravity of the electric hammer drill is positioned nearer to the axis of the cylinder, compared with the known art in which the components for the switching the operation modes are centralized in one area. As a result, operating vibration of the electric hammer drill is effectively alleviated.

Phillips discloses an electric drill that has a drive assembly and a pivot head having first and second bit gripping assemblies disposed at 90 degrees to each other. The electric drill also includes means for adjusting the position of the bit gripping assemblies relative to the drive assembly by pivoting the head through 90 degrees, whereby a selected one of the bit gripping assemblies is operatively engaged to the drive assembly. The position adjusting means may include a movable locking sleeve which, in a first position, allows the drive assembly to operatively engage the selected bit gripping assembly and, in a second position, allows the drive assembly to disengage the selected bit gripping assembly.

Mikiya, et al. discloses an electric drill apparatus having a low profile which comprises an annular cutter, a motor for rotating the annular cutter, a rotary shaft assembly for rotating the annular cutter attached to its leading end about a rotating, a rotation reduction mechanism disposed between the motor and rotary shaft assembly for transmitting a driving force of the motor to the annular cutter through the rotary shaft assembly, a feed mechanism responsive to an operation of a manual handle, for moving the rotary shaft assembly along with a straight line to advance or retract the annular cutter attached to the rotary shaft assembly with respect to a work piece, and an adhesion base for securing the electric drill apparatus to the work piece. The annular cutter has a plurality of cutting blades comprised of cemented carbide tips fixed on its lower end; thereby it is capable of rotating at a high speed. The rotary shaft assembly has a rotating shaft which rotates in a direction different from that of a rotating shaft of the motor; thereby the drill apparatus has a low profile.

Fields discloses a T-bracket having a pair of spaced apart arms that support a housing containing a sprocket wheel and a shaft to turn the sprocket. A handle attached to one end of the shaft turns the sprocket to tighten a chain turning on the sprocket teeth. A flexible wire rod is welded to the T-bracket and is juxtaposed around a rear end of a power drill. The chain is looped around a work piece and attached to a side of the drill opposite from the T-bracket. The handle is turned to tighten the chain and exert force on a drill bit being driven by the power drill.

Languasco discloses an apparatus for a releasable attachment to an electric drill housing that includes a flexible base member, a bit holder and a flashlight. The positions of the bit holder and the flashlight are adjustable relative to the base member and a flashlight head of the flashlight can be adjusted relative to the flashlight body.

Le Picq discloses a drill guide that has a base plate with a hole for positioning on or above a work piece. A carriage assembly secures the drill with the drill bit disposed over the base plate hole. The carriage assembly telescopes on guideposts with a spring biasing the carriage assembly away from the base plate. An alignment clamp has a compressible element to securely encompass drill chucks of various diameters.

Ito discloses an electric sparking drill and a method for using the same to drill a hole in a work piece where at least one of a voltage applied to an electrode, the conductivity of a liquid applied between the electrode and the work piece during drilling, and a gap between the electrode and the work piece are controlled to create the desired hole in the work piece. The electric sparking drill and a method for using the same to drill a hole in a work piece also improve the hole operation and/or the quality of the hole made by operating at the arcing voltage, including a touch stop function, including a sacrificial electrode, and/or including a guide member function.

Albrightson discloses a right-angle accessory saw for use with an electric drill that comprises a drive shaft housing and a saw head. A drive shaft is mounted for rotation within the drive shaft housing. The drive shaft has a drill connection end extending outwardly from a proximate end of the drive shaft housing. The other end of the drive shaft extends through the housing to a cam, located with a distal end of the drive shaft housing. The saw head extends transversely from the distal end of the drive shaft housing. A push rod is mounted for reciprocating translation within the saw head. The push rod includes a cam follower on an inner end and a saw blade holder on an outer end. The push rod is spring-biased inwardly toward the cam. A saw blade is detachably mounted within the saw blade holder.

Ishiwata, et al. discloses a small hole electric discharge machine drill that is provided with a depth-specific processor and a tiltable unit operable in fluid. The turntable unit includes a first axis with a first center of rotation and a second tilting axis with a second center of rotation. The turntable unit is provided inside a work tank that may be filled with fluid. The small hole electric discharge machine drill includes an electrode for small hole processing.

Frauhammer, et al. discloses an electric combination hammer for use either as a drilling hammer or as a chisel hammer has a housing and a handle arranged on it. The housing has arranged on it an on-off switch having a pawl and a switch element for manually switching from drilling operation to chisel operation and vice versa. Also arranged is a catch device by which the pawl may be engaged in chisel operation and which also prevents a latched position from being engaged in drilling operation. The catch device has a catch bracket having two legs which are connected by a joint and may be brought into operative connection with a blocking element that blocks the joint in at least one pivot direction to establish the catch function. The catch device also has at least one catch element which may be brought into operative connection with another catch element that is in operative connection with the pawl.

Shih discloses a combination drilling/tapping electro-discharge machining (EDM) drill capable of selectively operating in hole drilling mode or thread tapping mode is provided. The EDM drill includes a rotation axis as a R axis driven by a servo motor; a machining axis as a Z axis driven by another servo motor being capable of switching between a default mode and a servo following mode for realizing a spark following; and a thread electrode extended down from the R axis through a guide; wherein a dielectric supply and said R axis rotates for performing said EDM thread tapping on a work piece.

Lin discloses an anti-slip type electric drill chuck mainly includes a body which is obliquely provided with three pawls for clamping a drill head. The outer surface of one end of the three pawls is provided with a threaded surface for engaging a tapered threaded hole in a bearing nut, which has an outer end with teeth, an end portion provided with a ball ring. A check nut protective sleeve encloses the ball ring and bearing nut, and has elastic pointed portions engage the teeth. A drive annular block engages the inner wall of the bearing nut. A front housing sleeve engages the drive annular block and surrounds the aforesaid components. The front housing sleeve is rotated by hand to advance or retract the pawls to thereby loosen or tighten drill head. When the pawls clamp the drill head, the check nut protective sleeve stabilizes the bearing nut to prevent slippage thereof.

Wightman discloses an electric hand drill system comprising a hand held electric drill containing a motor. A coupling ring with a radial slot is formed with an interior bearing surface positionable in contact with a recipient surface on the drill. A handle is in a cup-shaped configuration. A first disk is received upon the coupling ring and has indicia upon the exterior surface.

Tsai discloses a structure for enhancing torque output of an electric drill includes a torque output unit mounted in an inner housing of a torque control unit. The torque output unit includes an intermediate washer located between an internal gear and a locating gear ring to isolate other components behind it from any backward transmitted reaction force that is generated when the electric drill operates, making it possible to use economical plastic instead of expensive powder metallurgic locating gear ring and pinions, and to snap-fit instead of screwing a motor bedplate to a rear end of the inner housing. The locating gear ring is provided with stop lugs to engage with open recesses provided on the inner housing and the internal gear, preventing slippage of the torque output unit in the inner housing even at a large torque output.

Hsueh discloses a combination type electric drill chuck structure that is mainly mounted on an electric drill. The chuck includes a drive body having head and tail ends, the middle thereof being provided with multiple inclined grooves for receiving multiple clamp pawls; a fixed shell secured fittingly at the tail end of the drive body; a sleeve threaded seat threadedly provided at head end of the drive body for engagement with the clamp pawls; a percussion ring provided with a spring for engaging the sleeve threaded seat in normal condition; a movable shell that utilizes an adjusting ring to adjust upper and lower positions. When the user turns the adjusting ring, the position of the movable shell can be adjusted to engage or disengage the sleeve threaded seat or fixed shell so as to achieve various operating modes of automatic percussion locking, manual locking and locking positioning of the drill bit.

Tinken discloses a portable electric railroad rail drill apparatus that includes an elongated main shaft, a support frame, an electric drill, a clamp, a handle and a support leg. The support frame is reciprocally mounted to the main shaft for movement therealong between first and second ends of the main shaft. The electric drill is fixedly mounted to the support frame and reciprocally movable therewith along the main shaft. The clamp is mounted at a location adjacent to the first end of the main shaft for mounting the main shaft to a railroad track rail such that the electric drill is disposed adjacent to the rail and movable along the main shaft toward and away from the rail and is operable for drilling a hole through the rail concurrently with movement toward the rail. The handle is pivotally mounted to the main shaft and pivotally coupled to the support frame and extends upwardly there from such that the handle can be pivotally moved between forward and rearward positions to cause movement of the support frame along the main shaft and thereby the electric drill toward and away from the rail for drilling the hole through the rail and removing the electric drill from the hole. The support leg is mounted to the second end of the main shaft and extends in a substantially transverse relation thereto such that the support leg rests on the ground and supports and retains the second end of the main shaft above the ground.

Granado discloses a universal, quick connect, reciprocating saw attachment for electric drills is disclosed, designed as an adapter that converts a power rotary drill into a reciprocating saw. The present invention converts the rotary action of a drill into the necessary reciprocating action to power a saw blade. The present invention adapts to the housing of various cordless drills and provides for a connection of a steel shank to the drill chuck. A gear box with a reciprocating mechanism inside the housing then provides a coupling to a saw blade to provide the necessary cutting action of a conventional reciprocating saw. Additionally, there are buttons that are designed to expand in and out to tighten the chuck which holds the adapter. The housing is made of a heavy duty impact resistant plastic with the associated gears and reciprocating mechanism made from hardened steel. Coupled with a cordless drill, and a saw blade, the present invention provides for the functions of two, usually separate, power tools in the convenience of one.

Hashimoto discloses an apparatus for holding an electric drill that is worn by a user including a pair of shoulder straps that pass over opposite shoulders of the user and which attach to a belt that is worn about the waist of the user at the front and back of the user. The belt is adjustable about the waist of the user. A holster is attached to one of the pair of shoulder straps intermediate the waist and one of the opposite shoulders of the user that is adapted to receive the electric drill therein. An optional wrap-around strap further secures the electric drill in the holster when it is not in use and an optional tether that is attached at one end to the tool holder and at a remaining end to the electric drill is provided as desired. An optional accessory pouch is attached to the one of the pair of shoulder straps opposite to where the holster is attached. An optional adjustable center strap is attached to each of the pair of shoulder straps and is disposed intermediate thereto in the front of the user. According to a modification the pair of shoulder straps include a hook and a loop fastener attached thereto at each end thereof which permit attachment of the pair of shoulder straps to a tool belt or to a convention type of a belt that worn about the waist of the user and is used to hold up a pair of trousers.

Setsuko discloses a centrifugal force-controlled coupling switch mechanism including a rotary base coupled between a reversible motor shaft of a reversible motor and an output shaft, an eccentric block pivoted to the rotary base and adapted for controlling engagement between the rotary base and the output shaft, a clutch adapted for controlling the engagement between the eccentric block and the output shaft, the clutch including a clutch body having two forward locating pins forced by a spring to disengage the eccentric block from the output shaft, and three smoothly curved actuating plates equiangularly retained to the clutch body by a spring retainer and forced by a centrifugal force to expand and to push the clutch body backwards in disengaging its locating pins from the eccentric block for permitting the eccentric block to be forced into engagement with the fixed coupling block of the output shaft by the centrifugal force when, the rotary base is turned with the clutch body by the reversible motor shaft of the reversible motor.

Khoury discloses a screwdriver adapted to be coupled to an electric drill for automatic rotation thereof including an interior member having a lower extent with a circular cross-section and a screwdriver tip at its end. The interior member has an upper extent of an enlarged cylindrical shape with a hexagonal component extending rearwardly thereof. An exterior cylindrical member of the screwdriver has a lower extent of a reduced diameter and an upper extent of an enlarged diameter and has an interior bore extending there through. The bore of the upper extent is adapted to receive the upper extent of the interior member and the lower extent of the exterior cylindrical member is adapted to receive the lower extent of the interior member with the screwdriver tip extending through the lower end thereof.

Thurler, et al. discloses a drill assembly including a drill and depth stop assembly is disclosed. The drill includes a housing, an electric motor and a chuck operatively driven by the electric motor about a drill axis. The depth stop assembly includes a depth stop rod, a mounting block, a fastener and a rotatable handle. The mounting block has a mounting surface adapted to cooperate with the housing, a first aperture spaced from the mounting surface for supporting the depth stop rod generally parallel to the drill axis, and a second aperture extending about a fastener axis generally normal the mounting surface. The fastener extends through the mounting block second aperture about the fastener axis and has two ends respectively cooperative with the housing and the handle to releasably entrap the mounting block there between to enable a user to adjustably position the depth stop rod relative to the housing. Preferably the fastener threadedly attaches to a threaded aperture in the drill housing. Ideally, the mounting block includes first and second mounting block halves which releasably clamp about the depth stop rod.

Enzmann, et al. discloses a gear mechanism preferably for use in an accumulator driven electric drill or electric screwdriver provided gear that comprises an overload coupling for limiting torque for the adaptation to various torque loads. The overload coupling is comprised essentially of an annular gear which is formed of a plastic material and which circumscribes and is associated with a planetary gearing, which has internal teeth which are in engagement with the planetary gear. A spring element presses against the annular gear, in order to press the annular gear axially against a detente wall, so that the annular gear is frictionally prevented from rotation, until a predetermined torque loading is exceeded and upon exceeding of the predetermined torque loading the annular gear is allowed to rotate. For this there is provided between the plastic annular gear and the spring element a metallic cam disk, which is non-rotatingly secured to the annular gear.

Chung discloses an electric hand drill set that includes a case constituted by a casing closeable by a cover to define therein a first interior space and a second interior space. A hand drill is received and removably held within the first interior space. A power converting and supplying device, such as an adaptor, is received and removably held within the second interior space. The power converting and supplying device has an extension cord adapted to connect to an external power source. The hand drill has and is powered by a rechargeable battery set which is electrically connectable to and thus chargeable by the power converting and supplying device. The charging of the battery set is indicated by a charging indicator. The cover has a window formed thereon, opposing the charging indicator to allow user to monitor the charging of the battery set.

Barth, et al. discloses an electric hand tool, particularly a drill, with a housing for an electric motor which is received in the housing and has a motor shaft parallel to the housing axis, and with a work spindle which is driven by the electric motor via transmission gearing, the housing being divided along a dividing plane for the purpose of switching from straight drilling to angular drilling and it is provided that the front housing part containing a bearing for the work spindle and the rear housing part containing the electric motor can swivel relative to one another in such a way that the work spindle projecting out of the front housing part can occupy any angle between 0 degrees and 90 degrees or more relative to the motor shaft. A catch lock which can be unlocked and/or locked manually stops the two housing parts in the selected swivel position. A torsionally rigid transmission of force from the motor shaft to the work spindle is realized in every swivel position of the housing parts in the transmission gearing.

Hwong discloses an invention that relates to an electric hammer drill and in particular to one including a housing, a motor disposed in the housing, a trigger mounted in the housing and connected between the motor and a power source, a gearing coupled to an axle of the motor, a shift rod having a vertical flat surface and a cylindrical surface so that the vertical flat surface will be spaced from an end of a spindle when the shift rod is at an predetermined position and the cylindrical surface will be in contact with the end of the spindle when the shift rod is rotated through an angle of 180 degrees, a chuck fixedly connected to the other end of the spindle, an inner serrated collar rigidly mounted in the housing, an outer serrated collar connected with the spindle and disposed against the inner serrated collar with teeth being opposite each other, and a spring for keeping the two serrated collars apart at normal condition.

Musil discloses an apparatus for supporting a paint stirring stick and for coupling to an electric drill comprising, in combination, a generally box-like container, the container having large parallel upper and lower walls, and small parallel side walls coupled there between, the container having an open front end adapted to receive a stirring stick, the device also having a closed rear end formed of symmetric walls adapted to close the rear end of the container.

Chang discloses an invention that relates to an electric drill characterized by a set of grinding equipment accommodated in an extended rear compartment of a housing of the electric drill. The set of grinding equipment mainly consists of a grinding wheel, a side cover having a through hole and an arcuate slot separately formed at proper positions, a cam capable of up-and-down and back-and-forth motion at some predetermined angles, a jig holder having a member to sequentially pass through a through hole of the cam and the through hole on the side cover and thereby becomes firmly associated with the cam and the side cover, and a drill jig being securely positioned and retained within retaining holes of the jig holder. The set of grinding equipments, when not in use, is concealed in the rear compartment, and, when it is to be used to grind a drill bit, the side cover is opened outward to expose the jig holder and the drill jig, the drill bit to be ground is inserted into a chunk of the drill jig, then the electric drill is powered so that a rotating shaft of the electric drill drives the grinding wheel to turn and grind the drill bit. The set of grinding equipments only occupies small room while it can timely and conveniently grind a drill bit in use.

Watanabe, et al. discloses an electric hammer drill including a vacuum dust collecting device for collecting dust from an area of an article being drilled by a drill bit wherein a hose extending from a body of the hammer drill is directly connected to an end of a movable first pipe which is slidably received in a stationary second pipe. A fan for transporting the dust by vacuum is fixed on a shaft extending across a dust collecting chamber in the body. The shaft is coaxial with, and releasably coupled with, an armature shaft of a motor. With this releasable coupling, the armature shaft is relatively short and unlikely to bend or flex, so that vibration produced during a drilling operation is small. During the drilling operation, the first pipe slides back and forth along the second pipe as a suction hood moves in a direction opposite to the direction of movement of the drill bit. Since a sliding portion between the first and second pipes is separated by the hose from a path of conveyance of the dust, the first pipe and the hood connected thereto always move smoothly relative to the drill bit.

Sheen discloses an invention that relates to an electric drill with speed and torque control and in particular to one which utilizes a single adjuster ring to control output speed and torque. When the adjuster ring is turned, the transmission axle will engage with another gear thereby changing the output speed. Further, in the meantime, the force exerted on the driven gear will be changed to adjust the output torque. The clutch and the driven gear are engaged by means of steel balls received in the recesses thereof.

Chen discloses a sawing device attachable to regular electric drill, having a main body with a revolving shaft set there inside to protrude there beyond to drive an inner spiral gear set to rotate so as to further let an eccentric strut on a longitudinal gear push and pull a front link rod to make reciprocating motion to further carry the front prolonged saw blade to saw; said main body comprising a drill sleeve for fixation with regular electric drill tool to let the revolving shaft be fixedly connected with the revolving body of an electric drill so as to make use of the revolving power of the said electric drill to drive the sawing device to saw.

Sorensen discloses a sonde that has an at least approximately cylindrical drill-stem member, whereby the drill-stem member may be coupled with other drill-stem members into a drill string. A spiral winding is longitudinally about the drill-stem member for conveying drilled out earth up to a surface of the earth when the drill-stem member is rotated into the earth, whereby the drill-stem member is an auger. At least one longitudinal surface portion of the drill-stem member is an electrical insulator that extends inwardly of the surface portion at least part of a radius of the drill-stem member. At least one measuring electrode is embedded in the electrical insulator. A connecting arrangement is in the drill-stem member for connecting the measuring electrode to electric operation and measuring equipment, whereby the auger is also an electrically logging sonde.

Hayes discloses a dielectric cover that is detachably coupled, in enveloping fashion, about the motor casing portion of an electric hand drill of pistol form with a front portion extending beyond the drill shaft projecting from the front end of the drill casing. The cover acts as a torque tube to support a right angle drive reduction gear mechanism which terminates in a drive wheel rotating about an axis perpendicular to the drill shaft axis and within a friction drive mechanism, completed by spring biased idler wheel pressing sidewise against the drive wheel. Metal blocks mounted to the cover connect to one side of a DC source and mount a wire guide for guiding a thin wire first electrode into contact with and between the drive wheel and the idler wheel. The wire electrode which is frictionally pulled from a spool borne by the cover feeds through a conductor tube of an electrode nozzle assembly. The conductor tube receives an inert shielding gas which flows about the thin wire first electrode and the arc. The variable speed drill uses the trigger mechanism to control wire electrode feed speed and thus the amperage of the weld arc, with work piece functioning as the second electrode. Owing to the inherently stable arc as derived from storage batteries, arc and drive power sources require no stabilizing interlock and may thus be entirely separate or identical, as convenience may dictate, without affecting either arc or drive either beneficially or adversely

Heinsius, et al. discloses a spirit level accessory for an electric drill that consists of a clamp member to fit on mounting surface of the electric drill, a dial member mounted on the clamp member and adjustable to obtain correct position with respect to center line of the electric drill, a bracket member held at any desired angle to the dial member by a spring force, a spirit level member held by the bracket member and a cover member having a mirrored inside surface and hinged on the spirit level member to protect the spirit level member against damage when not in use, allowing the spirit level member to be viewed when fully opened and viewed from the mirrored inside surface when halfway opened.

Fallon discloses an invention that relates to a case for displaying and storing electric tools such as a mini-drill and the case also contains a shelf (38) for displaying and supporting accessories (14) usable with the mini-drill (12), together with a compartment on the back of the case for receiving a source of electric energy such as rechargeable or non-rechargeable batteries suitable for feeding electric power to the mini-drill.

### SUMMARY OF DISADVANTAGES OF PRIOR ART

No examples of prior art address the problem of drill walk. See Table 1 for a summary of prior art. Many shortcomings are resolved and many enhancements are presented but none address the issue of the drill skidding sideways when encountering an unusually hard discontinuity within the work piece. Ordinary drills offer portability, low weight, high torque, reversibility and long life, both corded and battery. Hammer drills are very effective in using high frequency shock in drilling hard, dense material. But no drill nor drill attachment on the market offers an antiskid feature as does the present invention.

### OBJECTS AND ADVANTAGES

### Advantages

Objects and advantages of the present invention are:
A means of holding a rotating drill at a fixed (x, y) location when operating on hard, dense, brittle, non-homogeneous material
A means of forcing a plurality of metal pins into the surface texture of the work piece so as to resist lateral force thus holding the anti-skid assembly including the drill bit, to the location at which the drill bit was started.
An advantage is the tendency of the spring array to urge the drill bit to a perpendicular orientation relative to the work surface

### SUMMARY

In accordance with the present invention a means and method for holding a rotating drill bit in a precise location on a hard, textured work surface

### DRAWINGS

### Figures

### Preferred Embodiment

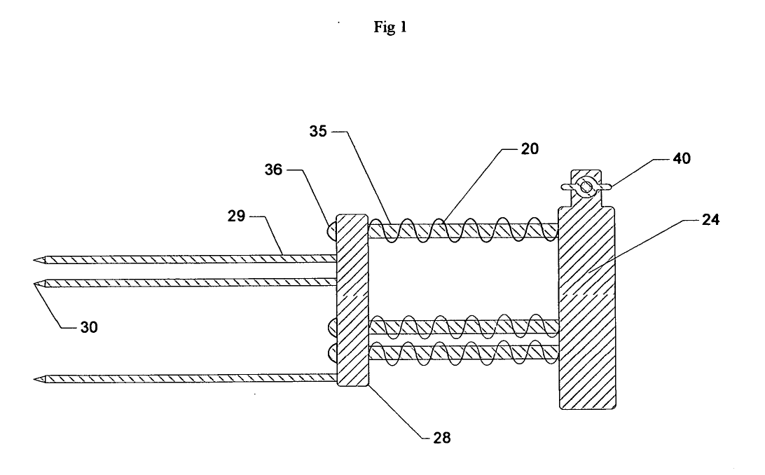

FIG. 1—Attachment at rest

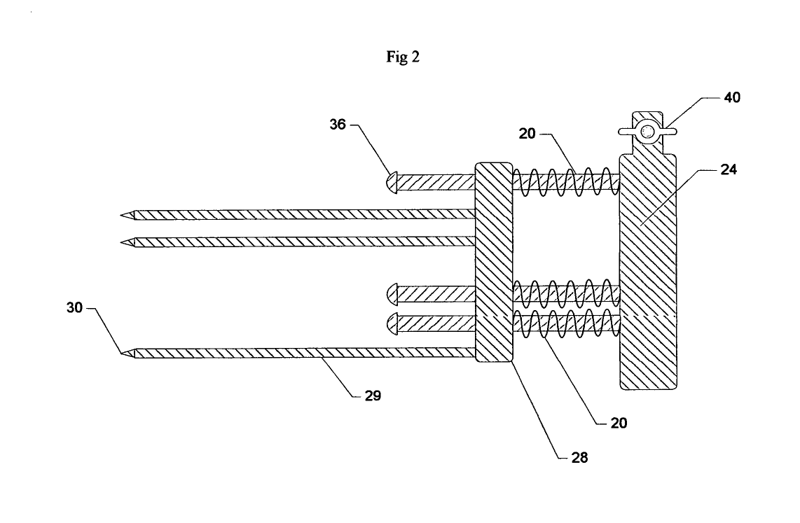

FIG. 2—Attachment in compression

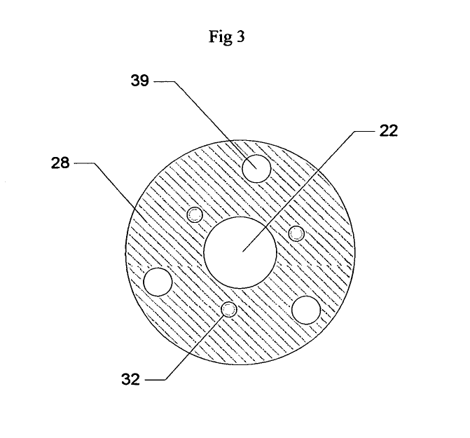

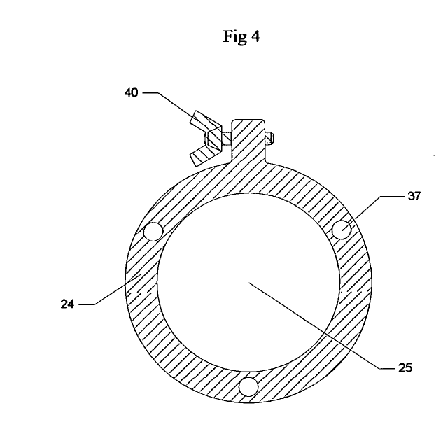

FIG. 3—Pin Ring

FIG. 4—Drill Mount

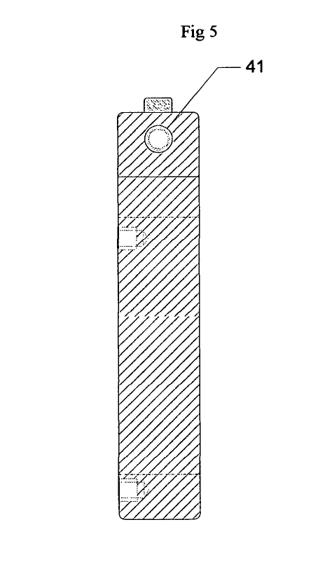

FIG. 5—Spring Rod Assembly

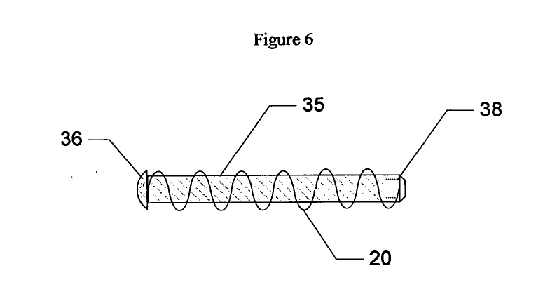

FIG. 6—Pressure Pin

### Additional Embodiment

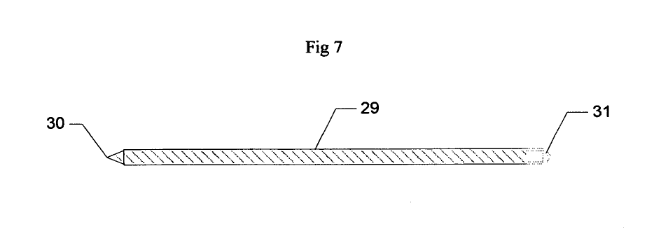

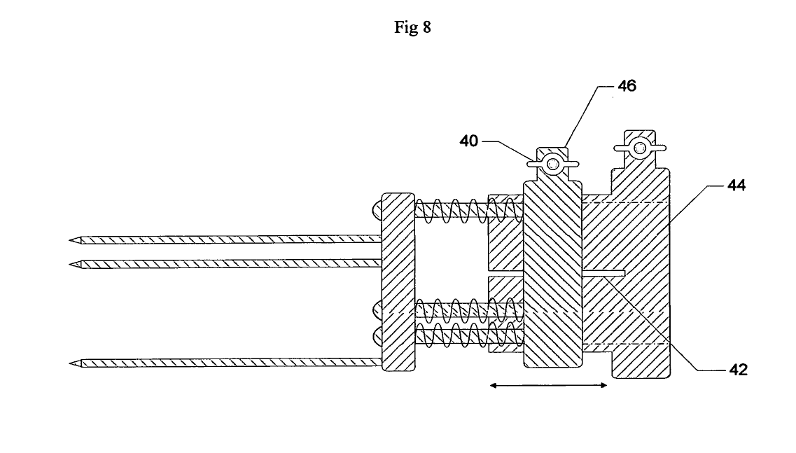

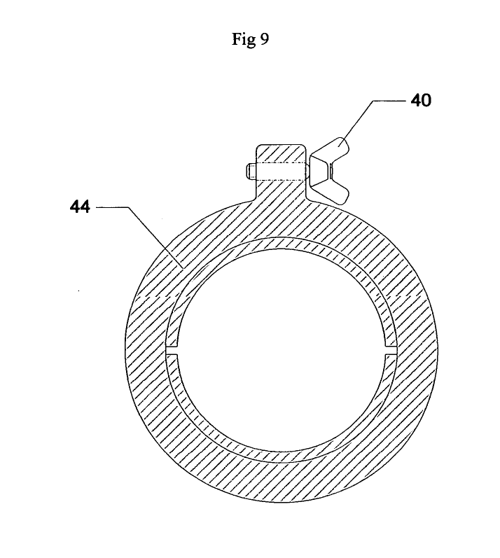

FIG. 7—Height Adjuster Assembly

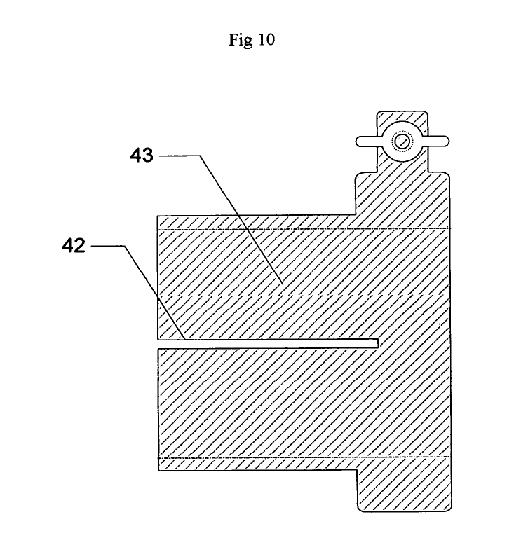

FIG. 8—Height Adjuster Mount

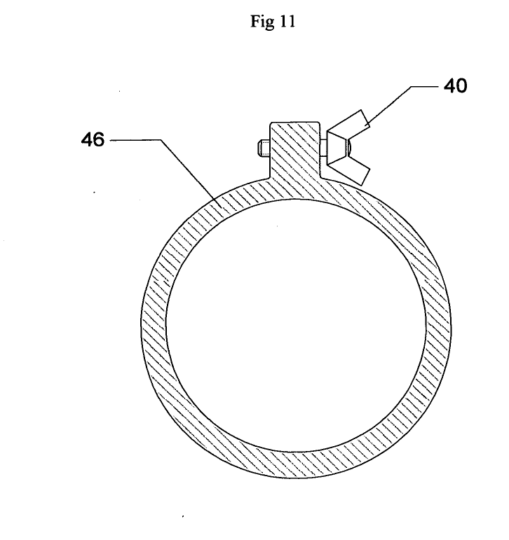

FIG. 9—Height Adjuster Slide

### DRAWINGS

### Reference Numerals

### Preferred Embodiment

10. Compression spring
11. Drill bit clearance through hole
12. Drill mount
13. Drill mount clearance hole
14. Pin ring
15. Pressure pin
16. Pressure pin point
17. Pressure pin threads
18. Pressure pin threaded blind hole
19. Spring rod
20. Spring rod end cap
21. Spring rod through hole
22. Wing screw
23. Wing screw through hole

### Additional Embodiment

24. Compression slot
25. Drill mount barrel
26. Height adjuster drill mount
27. Slide collar
28. Slide collar wing screw

### DETAILED DESCRIPTION

### FIGS. 1 through 7 Preferred Embodiment

FIG. 1 shows the attachment at rest. Compressions springs 10 are in slight compression to hold pressure pins 15 in position. The drill bit point is flush with pressure pins 15 so the user can locate the drill bit at the desired location.

FIG. 2 shows the attachment in compression. The drill bit has advanced through the surface of the work piece. Compression springs 10 are loaded forcing pressure pin points 16 to grip the textured surface of the work material. Drill and drill mount 12 are forced toward pin ring 14.

FIG. 3 shows the detail of pin ring 14. The outside diameter must be large enough to provide stability to the drill when pressure is applied along the drill axis while in operation. The inside diameter is chosen to allow for enough material to mechanically support spring rods 19 and pressure pins 15. Thickness must be sufficient to withstand lateral and torsional forces from pressure pins 15 and to maintain the perpendicularity of spring rod 19. Since most drill bit “walk” or “skid” takes place within the first inch of drill depth, design criteria is to maintain drill position for the first one and one half inches of hole depth. This depth is sufficient for most applications. If a greater depth is required, the assembly may be removed from the drill and the drilling operation continued. At this stage the hole will be deep enough that drill walk will not occur as it will be constrained by the first inch or so of the work piece.

FIG. 4 shows the detail of Drill mount 12. Drill mount thickness must be as great as possible to take full advantage of available surface area between the drill mount seat and drill mount since this is the only location the two are mated. Drill mount 12 inside diameter is chosen to mate with a standard drill that ordinarily receives a removable handle. The present invention is substituted where the removable handle would normally go. Outside dimensions and thickness are chosen to firmly anchor the assembly to the drill. Dimensions may vary depending on the material used. Wing screw 22 is sized to allow the assembly to be firmly attached to the drill.

FIG. 5 shows the detail of the spring rod assembly comprising spring rod 19 and compression spring 10. Spring rod 19 length is chosen to allow for full compression of spring 10. This effectively reduces spring 10 length by half. Spring rod 19 diameter and screw pitch are chosen to provide sufficient mechanical strength to withstand non-axial forces applied to the assembly during operation. Compression spring 10 is chosen to provide sufficient force to the work surface so as to hold the drill bit in place during operation.

FIG. 6 shows elements of pressure pin 15; these are point 16 and threads 17. Pressure pin 15 should be as narrow as possible to allow for compact construction. Point 16 should be hardened steel to maintain longevity when used on hard, abrasive surfaces. Threads 17 must have pitch, length and diameter compatible with pin ring 14.

FIG. 7 details the assembly with height adjuster. Height adjuster is composed of drill mount 25, slide collar 27 and slide collar wing screw 28. Drill mount 25 has a compression slot 24 to allow for tightening of wing screw 28. Height adjuster allows for a wider range of drill bit lengths.

FIG. 8 shows the detail of mount 25. Mount 25 is different from mount 12 in that is has compression slot 24 that allows mount 25 to be tightened over the full travel range of slide collar 27. Slide collar 27 is necessary to provide a means to accommodate drill bits of varying lengths.

### DETAILED DESCRIPTION

### Operation

### FIGS. 2 and 3

### Preferred Embodiment

The user may operate the Anti-skid attachment in the following manner:
1. Mount to drill by sliding drill mount 12 over the drill chuck so that drill mount 12 mates on the drill seat. Ensure pressure pins 15 are pointed towards work surface.
2. Tighten wing screw 22
3. Locate drill bit point in line with desired location on work surface

4. Force drill towards work surface until compression springs 10 are engaged and drill point is in contact with desired location.
5. Bear down on drill and squeeze power trigger.
6. Hold the drill perpendicular to the work surface and maintain pressure until hole depth is achieved

7. Relax pressure on the power trigger and withdraw drill bit from work piece.

### Additional Embodiment

1. Attach assembly to drill by sliding height adjuster drill mount 25 over drill and chuck so that drill mount 25 mates on the drill seat. Verify pressure pins 15 are pointed towards work surface.
2. Tighten wing screw 28
3. Slide collar 27 so that the drill bit tip is slightly behind pressure pin points 16.
4. Locate the drill bit point in line with desired hole location on work surface
5. Force drill towards work surface until compression springs 10 are engaged and drill point is in contact with desired location.
6. Apply pressure to the drill and squeeze the power trigger.
7. Hold the drill perpendicular to the work surface and maintain pressure until the desired hole depth is achieved or until compression rod end caps 20 contact the work surface.
8. Relax pressure on the power trigger and withdraw the drill bit from the work piece.

### ADDITIONAL EMBODIMENTS

A means for adjusting the position of the attachment so that the compression pins are located flush with or slightly ahead of the drill bit so as to be under compression before the drill bit makes contact with the work surface thereby assuring longitudinal grip on the work surface before the drill bit can encounter any material that may cause a lateral offset.

### ALTERNATIVE EMBODIMENTS

None

### CONCLUSIONS, RAMIFICATIONS AND SCOPE

The present invention addresses the often seen problem in construction and home improvement of drill holes in block or cement being ruined by deflection of the drill bit during the drilling operation. Usually this happens when the drill bit hits an area of particular hardness. It is impossible to predict. The remedies are often re-work of some sort, either filling the hole and drilling over, starting a new hole in a different location or accepting the oversized hole and upsizing the hardware intended for it. In build-to-print situations this requires a field red line to the drawing and new revision issued. In all cases, the fix is time consuming and costly. Two features of the problem give rise to the present invention; 1) the surfaces involved are always textured enabling the grip of hardened points with minimum pressure and 2) lateral stability is only required for the first inch and a half of drilling. After that there is too much drill bit in the hole to be pushed sideways

The present invention is to be used whenever there is suspicion that drill walk may occur. It mounts to the drill easily with one wing screw and in the option with the height adjuster, height is easily set to match drill length by sliding the assembly to the required position and tightening the second wing screw. Dimensions can be held to a minimum to avoid interference with the structure or other objects near the drill hole location. No exceptional parts or processes are required to manufacture. Operation is intuitive. Since mounting and dismounting are essentially a one step process, one unit may be shared at a work site. Costs can be held to a level that makes the unit attractive to both contractor and homeowner alike

I claim:

1. An apparatus (a) for attachment to and use with an electric hand held drill to hold the drill bit at the desired location when drilling through stone, cement, brick, concrete block or an aggregate of any of the aforementioned and a method (b) for using said apparatus:
a. In accordance with claim 1, an attachment generally comprising:
i. a first hollow cylinder with block affixed to the outside diameter, said block having a threaded through hole transverse to the axis of the cylinder through which a wing screw may be installed, said cylinder further having a plurality of equally spaced threaded blind holes
ii. a second hollow cylinder having a plurality of equally spaced through holes and a plurality of equally spaced threaded blind holes.
iii. a first plurality of cylindrical pins rounded on the first end and threaded on the second end.
iv. a plurality of compression springs
v. a second plurality of cylindrical pins pointed on the first end and threaded on the second end.
b. In accordance with claim 1, an attachment generally comprising aforementioned piece parts constructed in the following manner:
i. Said first hollow cylinder having an inside diameter suitable for mounting on a hand held power drill and having an outside diameter such that the cylinder may suitable grip the drill when subjected to compression by said wing screw and creates a face sufficient to receive said threaded blind holes into which said first plurality of pins may be installed.
ii. Said second hollow cylinder receiving, said first plurality of pins over which said plurality of compression springs is disposed and further receiving said second plurality of pins into said plurality of threaded blind holes on the opposing face.
iii. In accordance with claim 1, a method for using said apparatus, said method being defined in section “OPERATION” above.
Said apparatus enables the user to drill into rock, concrete, masonry, cement, cinder block or aggregate of non-uniform consistency without the drill bit “walking off” or skidding sideways from the desired hole location due to encountering a particularly hard or dense pocket of material. The present invention holds the drill bit in place by virtue of pins under compression gripping the textured work surface thereby preventing lateral movement. The present invention is designed to hold the drill bit in place for up to one and one half inch of hole depth. Shallow hole depths are most likely to allow for drill walk. After said depth is reached, drill walk is unlikely since there is a sufficient length of drill in the material to preclude it.
